(19) United States
(12) Patent Application Publication
(10) Pub. No.: US 2012/0036356 A1
(43) Pub. Date: Feb. 9, 2012

(54) Method for Accessing Nominative Data Such As a Customised Medical File From a Local Generation Agent

(76) Inventors: Herve Barbat, Nice (FR); Jabir Abdelaali, Marrakech, MA (US); Patrick Coudert, Roquebrune Ca Martin (FR)

(21) Appl. No.: 13/119,975

(22) PCT Filed: Sep. 18, 2009
(86) PCT No.: PCT/FR2009/001106

§ 371 Date: Jun. 9, 2011

(30) Foreign Application Priority Data
Sep. 19, 2008 (EP) 08368018.1

(51) Int. Cl. G06F 21/24

(52) U.S. Cl. 713/165

(57) ABSTRACT

A process of accessing to a customized computer file, comprising data of technical nature such as medical data as well as highly confidential nominative data. The process comprises the implementation of a generation agent of the customized computer file (DMN) contained in a storage device (20), such as a USB biometric key. The storage device (20) further comprises an encryption/decryption file and a matching table (PLT) of the links between the nominative data and an anonymous identifier (IDA). The generation of the customized computer file comprising the DMN data further implements:

a database on a first server (DMA, 300) only comprising anonymous information encrypted with said encryption key and related to said anonymous identifier (IDA), excluding any nominative-type information;

a set of tables on a second server (TSB, 400) comprising data for updating said tables (PLT), encrypted by using said encryption key;

a document database on a third server (GED, 500) comprising attached files contained in said customized file, indexed via said anonymous identifier (IDA) and encrypted by using said encryption key contained in said storage device (20).

### TECHNICAL FIELD OF THE INVENTION

The present invention relates to the information handling systems, and in particular to a process for accessing a customized electronic, comprising technical data and nominative data.

### BACKGROUND ART

Nowadays, the information handling systems are fitted highly sophisticated techniques so as to guarantee the safety and the confidentiality of the data particularly when such data covers sensible information like nominative information belonging to users.

As it is known in the art, the systems and the accesses are conventionnaly secured by a systematic use of passwords, by the use of processes of encrypting of files and the accesses to the networks are secured by means of specific techniques, such as protocol HTTPS for Internet network and WEP (Wireless Encryption Protocol) for the wireless networks.

Despite the existence and effectiveness of such security techniques, some applications, in particular in the medical field, give rise to very specific needs.

The medical field is indeed a very specific field wherein it is necessary, firstly, to guarantee the safety and the confidentiality of information but, secondly to allow some dissemination of information when such information is no longer specific to the identity of the users.

As it is known, the very specific relationship between a patient and his doctor is specifically protected by the professional secrecy, which is absolute, and the infringers are severely sanctioned in most of the countries.

This professional secrecy obviously covers the customized medical file of the patient, which must be as much as possible secured.

For as much, this medical secret should not however prevent the communication of the electronics files by means of electronic communication systems, not only for the purpose of satisfying the particular interest of its holder, but also and to a lesser extent, for allowing a certain “communication” for a more general interest.

First of all, as far it concerns the particular and private interest, one obviously recalls that, with the image of the contemporary patient who becomes nomad, it is necessary to allow an inspection of files by modern means of communication in order to give possibility to a patient, moving through the planet, to have an access, at any time and wherever he resides, to his file.

Then, concerning the general interest, it is appropriate to observe that some elements of a medical file—in particular aspects related to pathology, diagnostic and treatment excluding any nominative elements—can be of great interest for the community of practitioners and more generally the diverse professions of health. Practitionners feel necessary, in order to continuously improve practice rules advance the rules of good medical practice, to discuss and exchange views about the clinical and medicalized aspects of “their” patients. In a more general way, the medical research—which is the guarantee of medical quality which is improved every day, takes great advantage of all the statistical and collective data exchanged within the community of the professionals.

Consequently, under the lighting of the preceding observations, one sees that the processing of medicalized data requires specific techniques for taking into account this double requirement:

1. to guarantee in an absolute way the respect of the professional secrecy which covers the particular relation between the patient and his doctor, and

2. to allow a certain “diffusion” of certain elements—which are not nominative and perfectly anonymous—so as to provide support to a collective treatment of data and more generally to serve the medical research.

It is thus desirable to provide a specific tool, perfectly adapted to such a need and dilemma, while allowing to organize a specific treatment of this highly significant data.

This is the technical problem to be solved by the present invention.

### SUMMARY OF THE INVENTION

The object of the present invention is to propose a process of treatment and inspection of a customized electronic file, comprising technical data and in particular medical data, and other highly confidential nominative data.

The object of the present invention is to propose a process of treatment and inspection of medicalized data ensuring a perfect data confidentiality while allowing to the patients to remotely access their file, and this in spite of the intervention of third parties, even if the latter are considered to be confidence worthy.

Another object of the present invention consists in proposing a process of treatment and inspection of medicalized data allowing to obtain an anonymous access of certain elements of the customized files, while guaranteeing a perfect anonymity on the extracted data.

It is another object of this invention to provide a process of treatment and inspection of medicalized data, to be used for the practitioners, allowing to guarantee to the same practitioners a perfect control of the anonymity of their patients even when computer management is intervened by external servers managed by third parties of confidence.

The invention achieves these objects by means of a process of accessing to a customized computer file, comprising data of technical nature such as medical data as well as highly confidential nominative data. The process comprises the implementation of a generation agent of the customized electronic file (DMN) contained in storage device. The storage device further comprises an encryption/decryption file and a matching table (PLT) of the links between the nominative data of a patient and an anonymous identifier (IDA). The generation of the customized electronic file comprising the DMN data further implements:

a database on a first server (DMA, 300) only comprising anonymous information encrypted with said encryption key and related to said anonymous identifier (IDA), except any nominative-type information;

a set of tables located on a second server (TSB, 400) comprising data for updating said tables (PLT), encrypted by using said encryption key;

a documentary database on a third server (GED 500) comprising attached files contained in said customized file, indexed via said anonymous identifier (IDA) and encrypted by using said encryption key contained in said storage device (20).

In a preferred embodiment, the storage device held by the practitioner is an external memory support offering a high level of security on the data which is stored therein.

In a particular embodiment, the encryption key is obtained in a random manner during the installation of said DMN agent in the first external storage device that is used.

In a preferred embodiment, the installation of the first storage device comprises the following steps:

checking the practitionner's password;

random generation of an encryption key stored in said storage device;

input/importation of a nominative list of patients handled by the considered practitioner,

transmission of a request to said first DMA server in order to obtain the downloading of a list of IDA anonymous identifiers corresponding to the locally stored nominative list,

creation of the first PLT table of links integrating the nominative information as well as the anonymous identifiers known to the DMA server;

encryption of said PLT table of links by means of the randomly generated encryption key.

According to another aspect of the invention, it is arranged a procedure of duplication/qualification of a storage device source for creation/qualification of a second storage device allowing the generation of the customized medical file and the access to the nominative data (DMN).

For this purpose, the DMN agent of the first storage device applies the following steps:

password checking of the holder of the first storage device being used as source for the duplication;

checking of the presence of the encrypted PLT table and of the file comprising the encryption key;

checking the password of the holder of the second storage device;

creation on said second storage device of the files comprising the executable file of DMN agent, the encrypted PLT table of links as well as the file of the encryption key used by the first storage device;

According to preferred embodiment, the creation/qualification of any storage device leads to the edition of a certificate and/or an electronic certificate.

Preferably, the update of the storage devices belonging to the same group (and concerning the same encryption key) is obtained by means of a procedure comprising the following steps:

input followed by the encryption of nominative data modified or relative to a new patient;

transmission of a request to the second TSB server for provisional storage, in an encrypted form by means of the encryption key contained in said storage device (20), of nominative information other than the anonymous identifier (IDA);

update of the local table (PLT) integrating new modified information;

encryption of the local table (PLT) by means of the encryption key.

In order to update its own PLT table, a storage device in conformity with the present invention applies the following steps:

password checking;

checking of the presence of the file comprising the encryption key and of the PLT table of links;

generation of a request transmitted to the first DMA server for obtaining the list of the anonymous identifiers stored in that serer;

identification of the list of anonymous identifiers (IDA) downloaded from said first DMA server;

decryption of the local PLT table of links;

comparison of the list of anonymous identifiers downloaded with that stored in the PLT table, in case of incompatibility;

generation of a request with destination to said second TSB server for downloading the nominative information which is temporarily stored therein;

update the local PLT table of links by means of information downloaded from the second TSB server;

verification of the update of all the storage devices of the same group and purge, if necessary, data stored on the second TSB server.

Finally, according to a particular embodiment, the process comprises the implementation of an administrator server allowing the management of the licenses as well as the management of the clearance of said second server when the update of all the storage devices belonging to a same group is completed.

The invention is particularly adapted to the inspection and the on-line use of medical data of professional sportsmen and high level Athletes.

### DESCRIPTION OF DRAWINGS

Other characteristics, objects and advantages of the invention will be apparent with the reading of description and drawings hereafter, only given as nonrestrictive examples. On the annexed drawings:

FIG. 1 illustrates the general architecture of a preferred embodiment of a process of treatment and inspection of medical data.

FIGS. 2A, 2B and 2C illustrate an example of data organization within the server DMA 300

FIG. 3 more particularly illustrates the contents of the TSB server 400 being used for the temporary storage (in an encrypted form) of data updated by the practitioner.

FIG. 4 illustrates the structure of a PLT table of links 21 that is stored in each of the protected external medium.

FIG. 5 illustrates the process allowing the installation of a first storage device 20 in the workplace of a practitioner belonging to a professional group, a considered organization

FIG. 6 illustrates the process of duplication of a first storage device 20-1, carried out by the DMN agent, for the qualification of a second storage device 20-2.

FIG. 7 illustrates the process allowing to add/modify nominative data relative to an athlete.

FIG. 8 illustrates the process implemented to proceed to the update of PLT tables in the storage devices 20-n.

FIG. 9 illustrates the process of construction of the DMN file by the DMN agent.

### DESCRIPTION OF A PREFERRED EMBODIMENT

It will be now described an embodiment of the invention allowing, firstly, the handling, in a perfect secure way, of electronic medical files by health professionals generally exerting within the framework of a professional body.

The invention is particularly adapted to the intervention of professional contractors of the information systems, and brings a guaranteed confidentiality on the data, medical and nominative, contained in the files.

More specifically, the processing of the medical data belonging to professional sportsmen and high level athletes will be particularly considered in the embodiment hereinafter described. The medical data relative to these sportsmen and athletes is particularly sensitive and requires a high level of confidentiality to avoid any abuse of such data. Indeed, one knows that the advent of on-line sports betting, the fraud attempts are real and it is important to be able to carefully secure the nominative data of these “specific consumers” of medical care.

In that context, the high level athletes are naturally regrouped in groups (federations, leagues, clubs etc) to which is attached a whole of professional practitioners (doctors, kinesitherapists etc . . . ) exerting within a professional group.

The invention will be described in relation to such a context in order to illustrate the great efficiency of the processes being proposed. For as much, it is appropriate to point out that it is only a particular embodiment, making it possible to describe the organization of the means which are implemented and the technical advantages which result from these. It will be obvious for a person skilled in the art to adapt the teaching which follows to the installation of a more general system of computer medical data inspection of any patient.

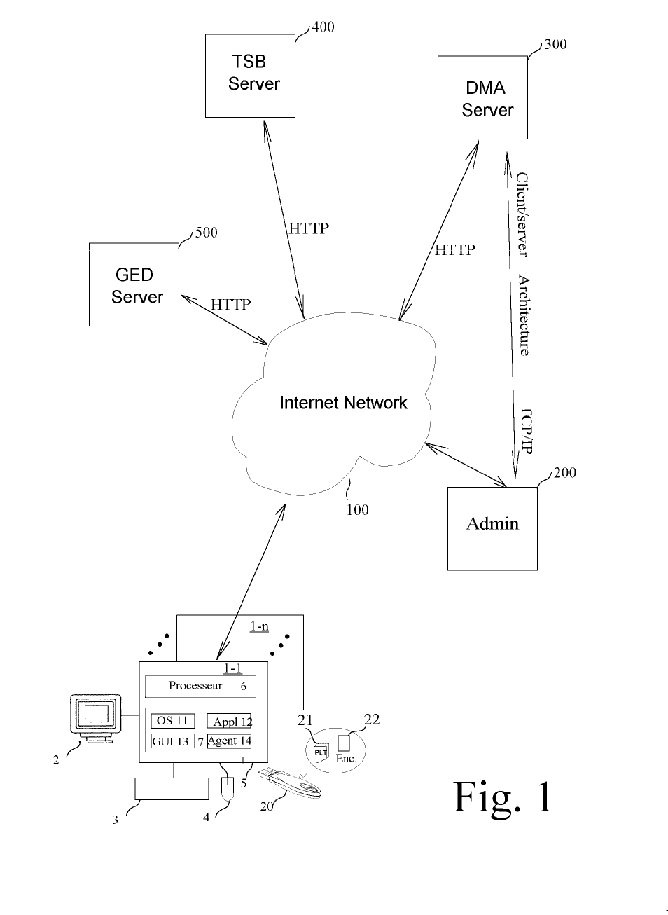

FIG. 1 illustrates the general architecture of a particular embodiment. Each practitioner belonging to a same group of professionals is given an access to a computer system, such as for example a PC computer 1-1 to 1-n (it is supposed that the considered group comprises N systems), equipped with a processor 6, storage means of which a RAM 7 in which it is found charged an operating system 11 is (such as WINDOWS (registered trademark) or LINUX for example), an application software 12, a module of user interface 13 as well as a DMN agent 14 for the implementation of the process hereinafter described. The 1-1 system is further equipped with input/output conventional means allowing the connection to a screen 2, a keyboard 3, a pointing device such as a mouse 4, as well as specific ports for the connection of the adequate peripherals, for example a peripheral serial of the USB type (Universal Serial Bus) or IEEE1394 (firewire).

In a preferred embodiment, the 1-1 system has at least one serial port 5 adapted to receive a storage device 20, taking the form of a protected external medium.

Each practitioner exerting within the professional group is considered to have its own external medium of protection which will be charged, with a certain number of files appropriate for the implementation of the techniques and processes which will be described hereafter.

Each of the 1-1 to 1-n systems further has communication means, particularly with the Internet network 100 so as to be able to access, for example via the HTTP protocol (Hyper Text Transfer Protocol) or any equivalent protocol, to external servers, and in particular to a Administrator server 200, a DMA server 300 for the storage—encryption—anonymous medical data, a TSB server 400 for the storage—encryption—temporary nominative data as well as a GED server 500 for the management of documents.

It should be noted that the server 200 will also be able to communicate with the DMA server by communication means of the TCP/IP type according to a customer-server architecture well-known to a skilled person which will not be further elaborated on.

In addition, the practitioners may also be equipped with mobile communication systems, such as a laptop, a device of the PDA type (Portable Document Assistant—non illustrated), and even a mobile telephone of last generation allowing the exchange of information via Internet network.

Generally, in the context of the present description and in order to clarify what follows, the following definitions are adopted:

Nominative medical data (DMN): one considers, under this designation, the complete file of the patientcomprising administrative and especially nominative data (name, age, sex, characteristics, address, telephone . . . ) together with medical information (pathologies, diagnostic elements, treatments, etc . . . ).

As shown below, in order to guarantee a high level of safety for the data, DMN data is never stored on the servers according to the proposed approach which is proposed in the present invention. One will see that this data is generated, only upon request of the practitioner, directly and locally to its 1-1 system by means of the storage device 20.

Anonymous Medical Data (DMA)

It is aimed, in this category of only medical information, excluding any information of nominative character, such as the name, the address, the telephone coordinates etc. . . This DMA data, less sensitive than the complete DMN data is stored on DMA server 300 indexed by a non nominative identifier, indicated by IDA. Although it is less sensitive than DMN data, the access to server 300 is nevertheless protected by an encryption known only from the practitioners of the professional group considered and stored within the storage device 20f. Because of the nature of the stored information on server 300, the latter will have a purpose of providing elements of statistical nature allowing the practitioners and the health professionals in general, to access information of collective nature regarding the pathologies, the diagnostics and the treatments of the patients.

Temporary Storage Base (TSB). This base comprises encrypted information allowing a management of the updates of the storage devices 20 used within the considered professional group.

documents storage base (DSB): This base contains encrypted files corresponding to PDF documents or JPG image.

Generally, the servers 200, 300 and 400 store information which is encrypted by means of keys only existing within the storage devices 20 held by the only practitioners, namely the external memory mediums. In particular, the administrator who manages the administration server 200 does not hold, as it will be shown hereafter, the keys for decryption.

The storage device 20—namely the external medium in the considered example—comprises an executable file which is a DMN agent for the creation of DMN, using the diverse information present and disseminated in the various components of the network.

The storage device 20 further comprises a file including the public/private keys allowing ciphering/encryption and decryption of the information downloaded from servers 300-400-500 and stored on those servers. It will be noted that a skilled person will be able to use every known process of encoding/decoding in order to implement the present invention.

In addition to the encryption/decryption key file and the DMN agent executable file, storage device 20 further comprises a so-called PLT links table:

Link table (PLT): This table is used as a pivot for the exchanges between the different servers as one will see. Indeed, one gather into this table, and only into this table, the corresponding of the nominative information with the IDA index particularly used by DMA server 300.

According to one particular aspect of the invention, the nominative—highly sensitive—data and the purely medical data (pathologies—diagnoses—treatments)—which are simply sensitive—are the subject of a differentiated treatment.

The nominative data is stored in the storage device 20 held by only one practitioner and is particularly protected by the electronic means implemented by the processes of the invention (encryption key, biometric protection) which comes to support the physical protection brought by this same practitioner to his storage device.

The simply medical data is stored on an external server, and is protected—to a lesser extent—by a coding system obtained by a key which is stored by the practitioner.

According to one aspect of the invention, the DMN agent of the storage device 20, when it is implemented in the 1-1 system of the practitioner, proceeds to requests between its local PLT table but also the stored tables on distant servers DMA 300, TSB 400 and GED 500, in order to generate upon request, within the office of the practitioner, the customized medical electronic file of a given athlete.

The building of the customized medical electronic file is achieved by means of the correspondence between the nominative data contained in the PLT file and the anonymous medical data downloaded from the DMA server 300, accompanied with the downloaded attached files from the GED server 500 by means of the IDA anonymous link.

Because it is prepared upon request, the customized medical file is never stored on an unspecified server and its access remains under the complete control of the practitioner who is, then, the guarantor of the respect of the data confidentiality of its patient.

The DMA 300, TSB 400 and GED 500 servers only comprise non nominative data and which, in addition, are encrypted by means of an encryption key held by only one professional.

Consequently, the third parties which are requested to manage and lodge the servers 300-500 cannot know the data stored in these same servers.

The data confidentiality is thus guaranteed in a particularly effective way, because of the generating agent of the personal medical file of the patient.

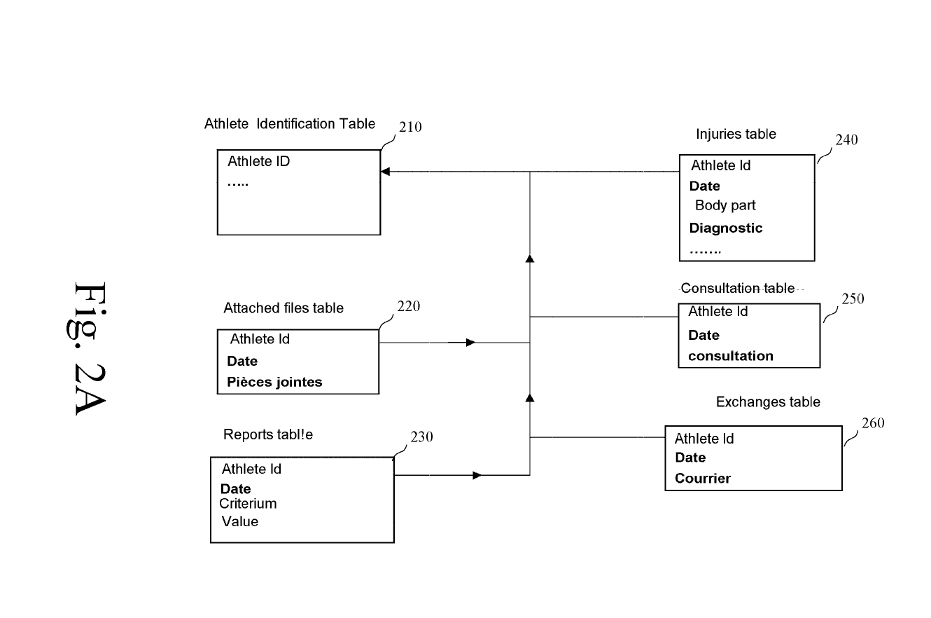

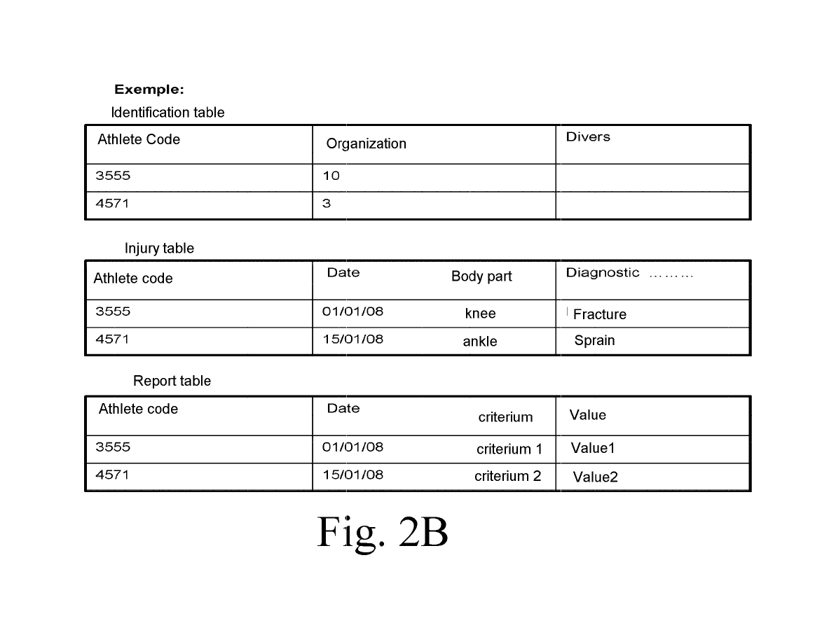

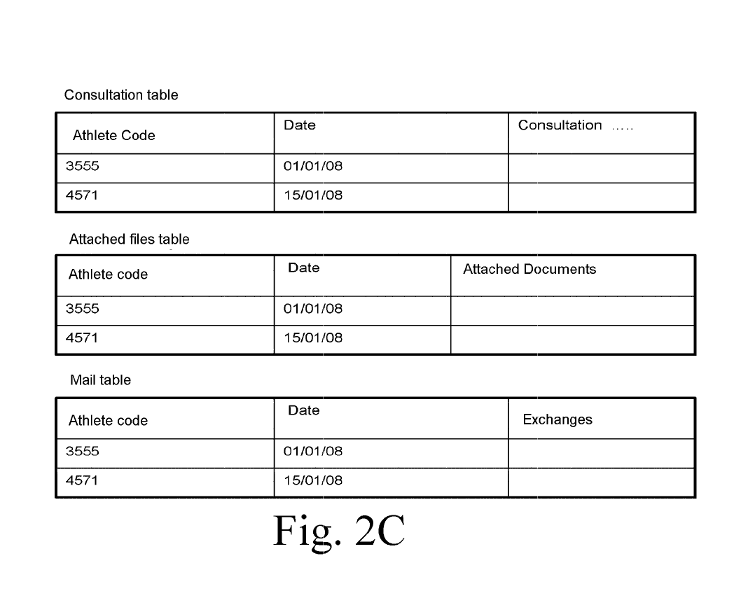

It is described now, in relation to the FIG. 2A, an example of structure of the data organization within the DMA server 300. As it is shown, this server comprises an ensemble of tables, which are the following:

Table 210: identification table of the athletes, which is indexed only by means of the IDA anonymous identifier.

Table 220: Attached files table. This table allows to regroup the attached files to the file, suitably dated, and stored (in an encrypted form) on the GED server 500.

Table 230: Reports table. This table allows to regroup, at a chosen moment, the encrypted values of the clinical results obtained by the patient.

Table 240: Injuries table. This table describes the history of the injuries having affected the patient.

Table 250: Table of consultations. This table collects the history of the consultations obtained by the patient.

Mails table. This table traces the date of the exchanges between the patient and his practitioner.

Generally, it is noted on the examples illustrated in the FIGS. 2A-2C that the majority of information is encrypted, which particularly lends to a later statistical treatment or a collective inspection of non nominative medicalized data. It will be noted that the term “organization” in the table 2B naturally returns to the code of the considered group of professionals (the club, the federation, league etc . . . ), which is also encrypted.

It will further be noted that the invention lends itself quite naturally to the systematic use of the codes resulting from the CIM classification (International Classification of the Diseases) as published in its last state (CIM-10) by the World Health Organization.

In the particular embodiment which is considered, namely a process of inspection of medical data for high level athletes and professional sportsmen, one will be able to even develop specific categories and subclasses in order to give an account of certain specific pathologies suitable for the sport or particularly interesting on a plan of statistical study.

As it is shown the server 300 has to constitute a medical database, but excluding all the nominative data, likely to serve the needs of inspection by the practitioners but also to studies of statistical order.

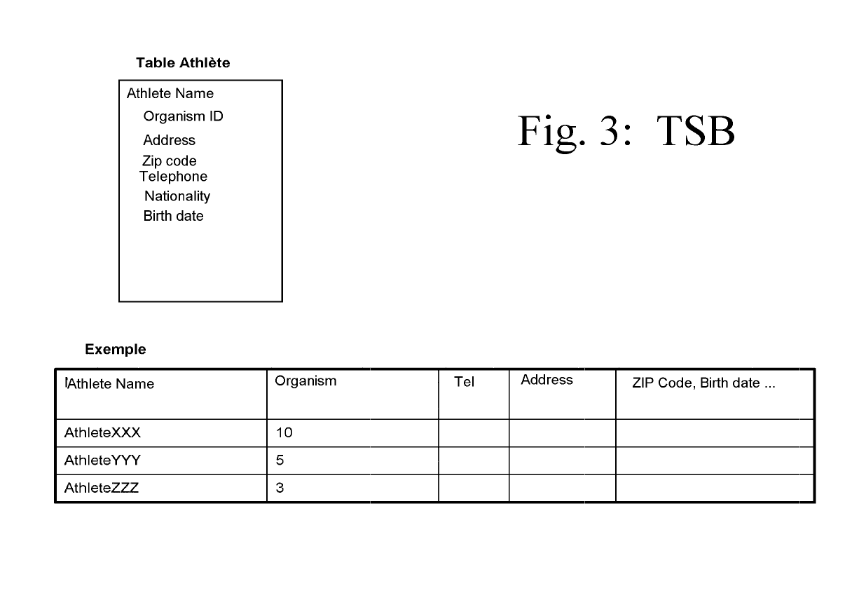

FIG. 3 more particularly illustrates the contents of the TSB server 400 being used for the temporary storage (in an encrypted form) of the data of updates by the practitioner. It should be noted, as one will see hereafter at the time of exposed protocols of requests and the further exposed procedures, that this TSB server 400 has as purpose a periodic purging or clearance of the statistical data, which results in an increase of the general security of the described process.

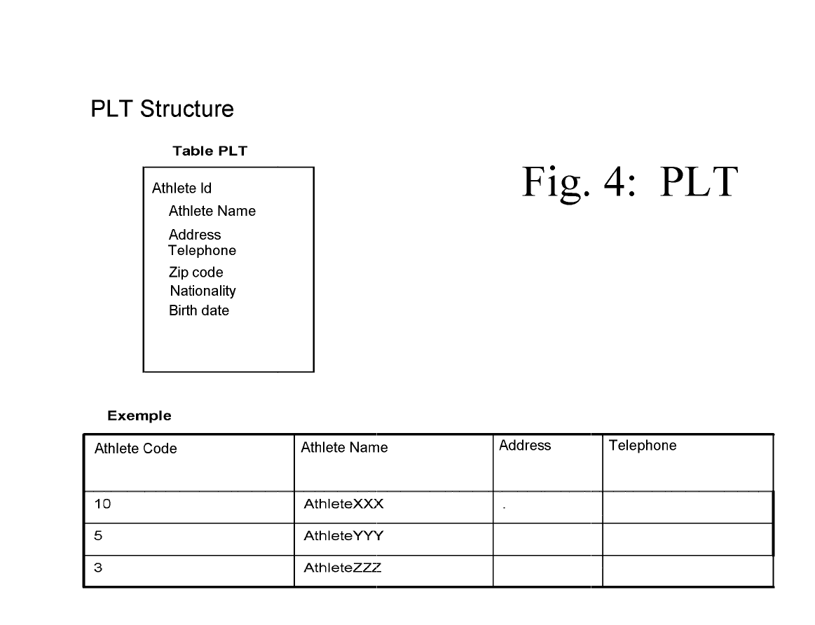

FIG. 4 illustrates the structure of the PLT table of links 21 which is stored in each storage device 20, such as for example the biometric keys illustrated in FIG. 1.

As it is shown, this table comprises, in addition to the IDA anonymous identifier, the identification elements of the athletes, namely the name, the address, the telephone coordinates, nationality, as well as profile elements associated with this athlete such as the age, the sex, the characteristic features (right-handed, left-handed etc . . . )

As it is shown, this PLT table 21 presents highly sensible data, and the process according to the invention will proceed, as one will see hereafter, with a particularly sophisticated treatment of these data in order to permanently ensure their confidentiality, while allowing a certain statistical and collective treatment on non nominative medical data.

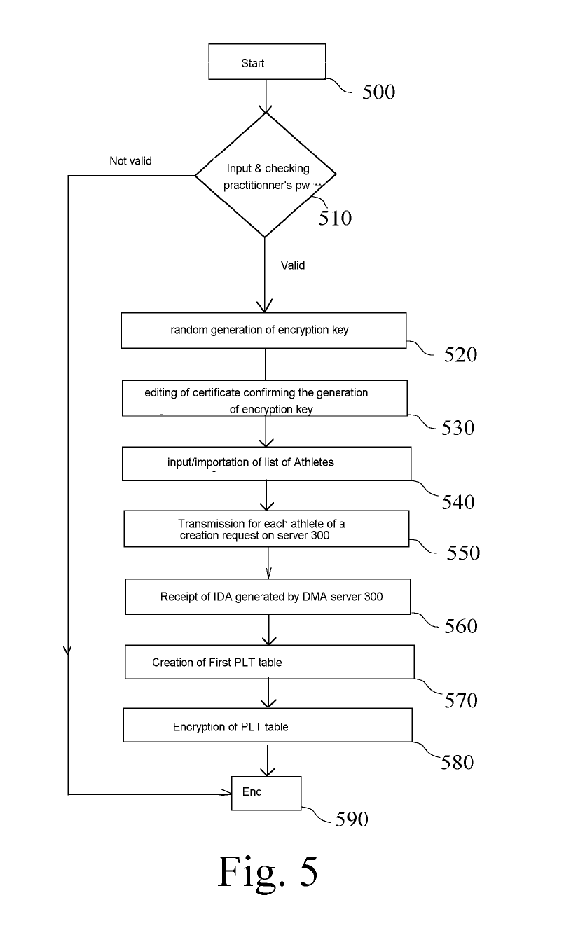

FIG. 5 illustrates the process allowing the installation of a first storage device 20 in the workplace of a practitioner belonging to a professional group, a considered organization.

The installation process is based on the implementation of the DMN agent whose operation is stored on the storage device 20. For this purpose, in the case of a biometric key, it is appropriate to observe that, since the insertion of this key in the USB port 5 of the system, the practitioner will be solicited to carry out its activation. Generally, the implemented principles and procedures for allowing the activation of a biometric key—in particular by the capture of a digital fingerprint—are well-known to a skilled person and do not form part of this invention. This procedure of activation will not be described in more detail and it will be restricted to recall that this one is based on a verification of the digital fingerprint presented by the practitioner and its comparison with a reference fingerprint already captured and stored within device 20.

One will be able to advantageously complete the biometric security mechanism of any other security mechanism, and in particular of a mechanism based on the capture of a “fingerprint” characteristic of the computer, and its components, on which is connected the biometric key.

Once the activation of the biometric key is made, the DMN agent can be executed and start, in a step 500, the installation procedure is illustrated in FIG. 5.

Then, the DMN agent proceeds to a step 510 which is the input and verification of the practitioner password.

If the test of step 510 succeeds, the process proceeds to a step 520. On the contrary, if the test fails, the process goes directly to the step 590 stopping the installation procedure of the biometric USB key.

In the step 520, the process proceeds to a random generation of an encryption key which, it should be underlined, will remain stored only in the storage device 20 in the Practitionner's office, as in the secondary keys of the fellow-members which will be duplicated as it will be seen hereafter.

Generally, one will be able to consider any procedure of encryption/decryption, and in particular the asymmetrical process of RSA type (Rivest, Shamir and Adleman) based on the use of public/private keys and largely on the use of Internet. One will also fix the length of the code of encryption according to a security level which one will wish to implement for PLT table. Again, the techniques of encryption are well-known to a skilled person and will not be exposed in more detail.

Then, the process proceeds to a step 530 during which the agent proceeds to the edition of an attestation or a certificate (possibly numerical) for the purpose of certifying the completion of the generation of the key of encryption/decryption. In a particular embodiment, the process obtains an impression of a certificate to be made signed by the practitioner and aiming at drawing his attention to the requirement of vigilance which is required from him in order to preserve the confidentiality of information present on the lately installed key.

The process proceeds to a step 540 aiming to the input or the importation of an athletes list either by direct input in the practionner's office, or by means of an importation starting from a file preexisting on the system under the responsibility of the practitioner. One will be able to consider that this step also comprises the input/importation of all the nominative data of the athletes while waiting for the construction of the first PLT table.

Once the input has been completed, the process proceeds to a step 550 during which a request of creation of new a IDA transmitted to DMA server 300 is generated, for each athlete listed during the preceding step. That lead to the creation of the necessary environment for the constitution of the indexed tables by the lately created IDA identifiers on the DMA server 300 and which will be updated later by the practitioners according to their diligence in relation to their athletes.

In a step 560, the DMN agent which is executed on the system of the practitioner recovers the lately created IDA for the creation of the structure of the first PLT table.

In a step 570, the agent then proceeds, if it has not already done it during the step 540, to the input/importation of the nominative data of the athletes, but also of data characterizing their profiles, in order to complete the generation of the PLT table as illustrated in FIG. 4. Again, several modes of embodiments can be considered, and in particular the direct input of nominative information by the practitioner or the importation of this same data starting from a preexistent file on the system of the practitioner. It is important to note that the nominative data of the athletes remain within the office of the practitioner, only under his responsibility, and is by no means stored on servers 200,300,400 or 500.

In a particular embodiment, one can anticipate to terminate by any no specified means the connection between the system of the practitioner and the servers 200-500 in order to prevent any diffusion of data while waiting for subsequent encryption of the PLT table.

The process proceeds with a step 580 during which the agent performs the encryption, by means of the randomly generated key during step 520, of lately created PLT table.

The process implemented in the DMN agent is then completed by the final step 590.

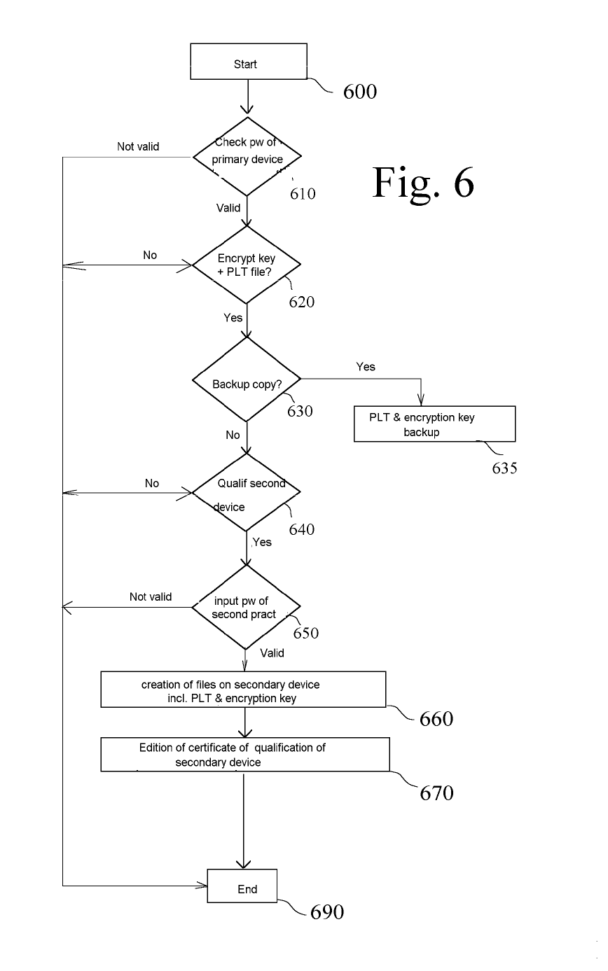

FIG. 6 illustrates the process, implemented by the DMN agent, of backing up and/or duplication of a source or primary storage device 20-1, for the qualification of a destination or secondary storage device 20-2 allowing a second practitioner to reach the DMN file of the athletes inspected by the professional group.

The process is implemented on the primary storage device starting by a step 600.

Then the process proceeds to a step 610 during which a procedure of verification of the holder password of the primary storage device is implemented, similar to the procedure described in relation to step 510 of FIG. 5. If the password is not identified as being valid, then the process is completed with a step 690.

If the checking of the password is validated, then the process goes towards a step 620, during which the agent being executed on the primary device verifies the presence of the encryption file as well as the presence of the encrypted PLT table.

If one of the two files is absent from the primary storage device, then the process goes to a step 690 and terminates.

On the other hand, if the two awaited files are present, then the process proceeds with an optional step 630 during which the DMN agent determines if the process must simply lead to a backup copy of the PLT file and of the key file of encryption. If yes, the process goes to a step 635 wherein the two files are stored on an adequate memory medium, under the responsibility of the practitioner.

In the contrary case, or when the step 630 is not anticipated, the process goes directly from the step 620 towards a step 640 during which the agent requires from the primary practitioner to confirm the opportunity of proceeding to the qualification of a secondary storage device for the creation of a second access key to the customized medical file and, in the contrary case, the process goes towards the final step 690.

If the primary practitioner confirms the qualification procedure of the secondary storage device, then the process goes towards a procedure 650 wherein the agent invites the secondary practitioner to insert his own storage device 20-2. On the assumption that the secondary device is, this also, a biometric USB key, the secondary practitioner will have to activate the latter in order to allow the writing of files and, consequently, the good implementation of the qualification procedure. The Step 650 also continues with a procedure of input/creation of a secondary password, which will be used by the secondary practitioner to access to the execution of its own DMN agent.

If the procedure of seizure/creation of password does not succeed, then the process goes to a step 690 and terminates.

On the other hand, if the procedure of password creation of the secondary practitioner succeeds and is validated, then the DMN agent who is executed on the primary storage device 20-1 proceeds in a step 660 to the generation of the necessary files for the execution of a new authority of the DMN agent, namely the executable file of the DMN agent, the file of encryption/decryption as well as the quantified PLT table, coming to complete the qualification of the secondary storage device 20-2, namely the second biometric USB key which will be used by the second practitioner.

Then, in a step 670, the primary agent proceeds to the edition of an attestation or an electronic certificate confirming the qualification of the secondary storage device 20-2.

Then, the process is completed by the step 690 completing the procedure of backing up/duplication.

It will be noted, and this is a significant advantage of this invention, that the process of duplication of the keys and qualification of the secondary storage device can also be used by the same practitioner who would wish to carry out a second “physical” copy of his USB key. In this case, it will be enough for him to input once again its password during step 650.

Thus, as it is seen, the process allows to manage very simply the primary, secondary, tertiary, etc. . . storage devices, which are likely to be useful within the same professional group. It is very easy, for the practitioners of a group, to carry out their own copies or duplication of this storage device which, it should be pointed out, is absolutely necessary for accessing the nominative data of the personal medical file of the athletes . . . Again, out of the professional office of the practitioners and without their presence, it is not possible, even for the administrator of the server 200, to access the nominative data.

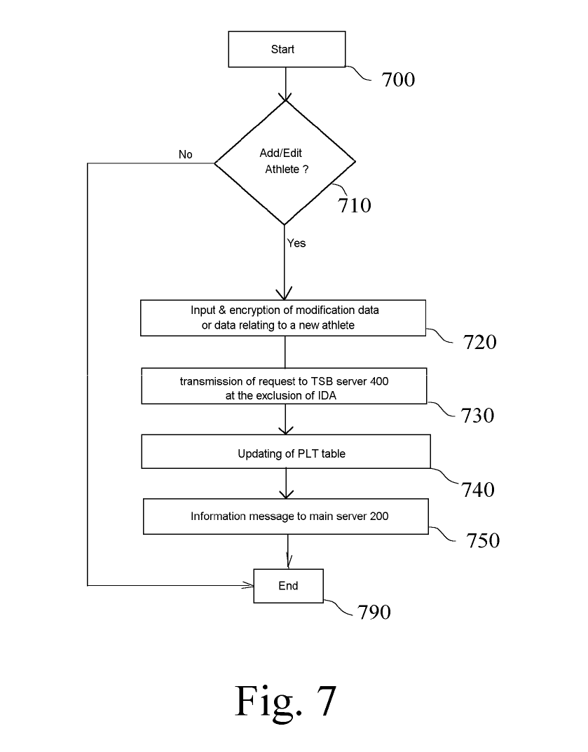

FIG. 7 illustrates the process allowing to add/modify nominative data relative to an athlete, by means of a storage device of 20-n.

Then, the process of accessing to the DMN and updating starts by a step 700. As previously, this step will be able to comprise, in addition to the essential preliminary step of activation of the biometric key 20-n, of the input of the password in order to allow the execution of the DMN agent allowing the on line construction of the DMN.

In a step 710, a test is performed for determining if it is necessary to add or to modify the information concerning an athlete.

If not, the process goes towards a final step 790.

If yes, the process proceeds to a step 720 during which the nominative data and the profile of the new athlete are input/imported by the practitioner and are encrypted by means of the encryption key being present on the storage device 20-n.

Then in a step 730, the process proceeds with the generation of a request transmitted to the TSB server 400, said request comprising information of updates input during the step 720, of however the IDA identifier.

That has as a significant advantage to not externalizing, out of the office of the practitioners, the matching table between the IDA and the nominative elements of identification of the athletes . . . As one observed, the table stored (for a very limited time) on the TSB server 400 only comprises nominative data (with the exclusion of medical nature element), while the DMA server 300 only comprises medicalized data but only in relation to a non nominative IDA identifier.

And, in addition, all the information stored on servers 300 and 400 is quantified by means of a key only held within the professional group of practitioners.

One can profit from an high security degree and this without resorting to particularly expensive techniques . . .

Following step 730, the process implemented by the DMN agent proceeds to a step 740 during which the PLT table is updated by taking into account the addition/modification introduced by the practitioner who is the holder of the primary biometric key.

The DMN agent then transmits during a step 750 a request to the principal server 200 intended to inform this one of the update introduced into the system. It should be noted that only the IDA identifier is transmitted in this occasion.

The process is then completed by the step 790 which finalizes the modification which has taken place within the tables.

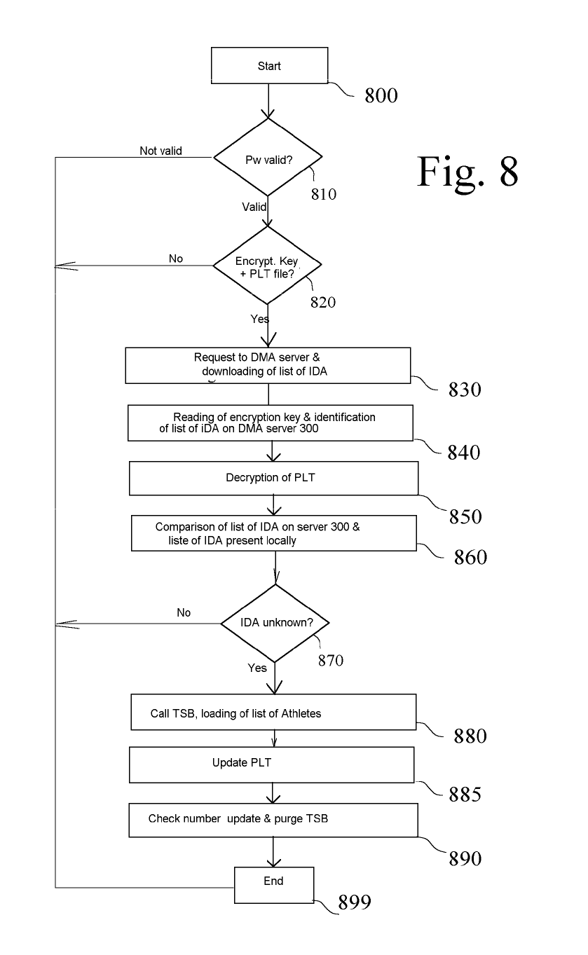

In reference to FIG. 8, one now describes the implemented process to proceed to the update of the PLT tables in the storage devices 20-n etc. . .

The process starts by a step 800. It is supposed, like previously, that the practitioner who launched the execution of the DMN agent on his storage device 20-n has satisfied the activation procedure of his biometric key.

In a step 810, DMN agent launches the password verification procedure which, if it fails, returns directly to a final step 899.

On the contrary, if the practitioner satisfies the verification procedure with his password, the DMN agent goes to a step 820 during which an additional test is performed in order to determine the presence of the file comprising the key of encryption/decryption as well as the PLT table.

If the test fails, the process also goes at the final step 899.

If the test succeeds, then the process goes to a step 830 wherein the agent generates a request with destination to the DMA server 300 with the aim of downloading the IDA list.

Then, in a step 840, the agent proceeds to the reading of the decryption key in order to obtain the IDA list being downloaded from the DMA server 300.

Then in a step 850, the DMN agent proceeds to the decryption of its local PLT table in order to be able to access the data present on the latter.

In a step 860, the DMN agent proceeds to a comparison between, on the one hand, the list of the IDA identifiers downloaded from the DMA server 300 and, on the other hand, the list of the IDA which are locally present on its PLT table.

In a step 870, the DMN agent proceeds to a test in order to determine if a IDA seems not being attributed to the one of the players specifically identified in its local PLT table.

If the test fails, that means that no update is necessary and the process goes to the final step 899.

In the contrary case, the process identifies one or more not attributed IDA identifiers, and then goes to a step 880 for transmitting a request to the TSB server 400 in order to download the list of the athletes.

Nominative information present on the TSB base 400 is then locally received by the DMN agent which, by means of its decryption key, can access and complete its local PLT table, in a step 885.

Then, the agent proceeds to a notification being transmitted to the principal server 200 in order to inform the latter about the occurred update. The latter can then ensure that all the storage devices 20-n of the same professional group were indeed updated and, if necessary, performs a purge of the stored table in the temporary TSB server 400.

The process is finally completed by the step 899.

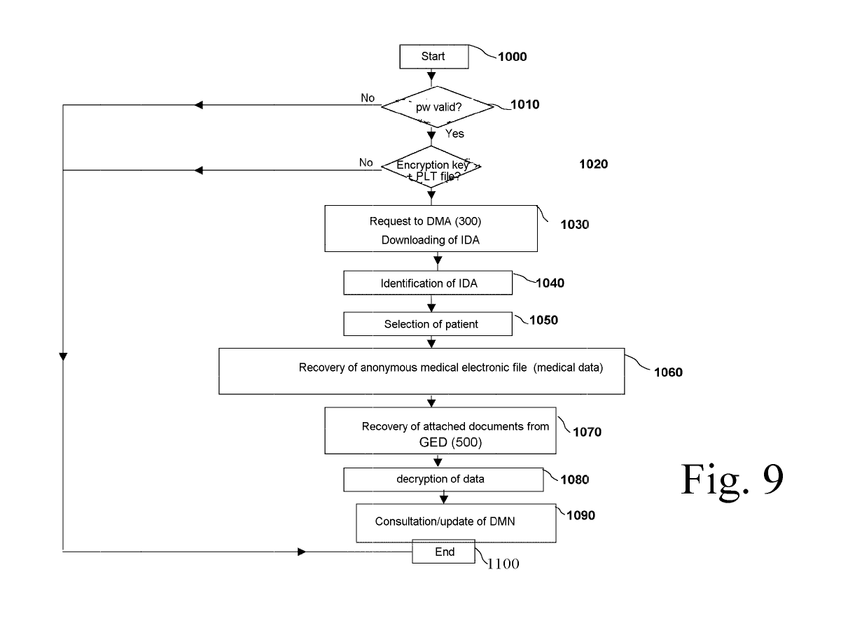

FIG. 9 illustrates the process of construction by the DMN agent of the customized medical file comprising the DMN data.

The process starts with the step 1000.

Then, in a step 1010, the DMN agent performs a password test in order to verify that the user is well authorized to provoke the construction of the DMN file and, in the case of a non valid password, the process goes at the final step 1100.

If the password is recognized as being valid, then the process proceeds, to a step 1020, with the verification of the presence of the PLT file 21 and of the file 22 comprising the encryption key on the storage device (for example the biometric key).

If the two files are not simultaneously present, then the agent goes to the final step 1100.

If the two files are present, then the agent generates, in a step 1030, requests directed to the DMA server 300, and proceeds to the downloading of the list of the anonymous IDA identifiers.

In a step 1040, the DMN agent proceeds to the identification of the patients by means of the matching table being stored in its security storage device.

In a step 1050, the DMN agent proposes the choice of a selection of one of the identified patients at the preceding step.

Then, in a step 1060, the DMN agent proceeds to the downloading of the anonymous data from the DMA server 300 by means of the private IDA attributed to the considered patient.

Then, in a step 1070, the DMN agent proceeds to the downloading of the attached files stored on the GED server 500.

In a step 1080, the process uses the encryption key present on the storage device protected by the practitioner who is the holder in order to decrypt the downloaded data from the DMA server 300 and the GED server 500.

The file is now complete and can be presented in a convivial manner by means of the graphical user interface GUI 13 represented in FIG. 1. This consultation is performed during a step 1090 also allowing to the practitioner to proceed to possible updates and modifications of the file of its patient, which updated could be downloaded through their respective servers (in particular DMA 300).

At the end of the consultation, the DMN agent 1100 goes to the final step in order to complete the process and erase from the memory any trace of the medical file of the patient.

The processes which have just been described allow to create, in a safe manner, the constitutive tables of the medicalized databases being the subject of particularly complex and guaranteeing treatment techniques, all at the same time, a high level of confidentiality and a collective and statistical processing of perfectly anonymous certain data.

Indeed, as it is seen, the personal medical files of a patient are created only at the workplace of the practitioner, and this by means of the DMN data generation agent 12 profiting from a double level of protection: the protection resulting from encrypting with the key being present only on the storage device 20, combined with the protection resulting from the biometric verification mechanism implemented in the practitioner's workplace.

Consequently, out of the practitioner's office or workplace, and without the recourse to the storage with biometric protection 20, it is not possible to reconstruct the medical electronic file of a patient without the knowledge of the practitioner, and the servers, in particular the DMA server 300 only comprises non nominative data (and also encrypted).

On the other hand, it is still possible, for a practitioner of the considered professional group or for a practitioner federating the instituted professional groups, to access to certain information elements, such as codes resulting from CIM-10 classification of the WHO for example, or any subjacent and/or distinct coding, in order to perform a collective treatment of this data, to proceed to a non nominative communication of this data.

By the average techniques which are implemented, the invention thus allows to perform a particularly satisfying bond between highly sensible data, the data stored in the PLT table which must remain absolutely confidential, and of the data likely to allow a collective treatment in order to advance the inspection of the files and/or the medical research.

1. Process for accessing to a customized electronic file, comprising data of technical nature, such as for instance medical data, and highly confidential nominative data, characterized in that it comprises:
the implementation of a generation agent of the customized computer file (DMN) in at least one storage device (20), said storage device further comprising an encryption/decryption file and a matching table (PLT) of the links between the nominative data of a patient and an anonymous identifier (IDA),
the implementation of a database on a first server (DMA, 300) only comprising anonymous information encrypted with said encryption key and related to said anonymous identifier (IDA), excluding any nominative-type information;
a set of tables on a second server (TSB, 400) comprising data for updating said tables (PLT), encrypted by using said encryption key;
the implementation of a document database on a third server (GED 500) comprising attached files contained in said customized file, indexed via said anonymous identifier (IDA) and encrypted by using said encryption key contained in said storage device (20).

2. Process according to claim 1, characterized in that said storage device is a USB type biometric key.

3. Process according to claim 1, characterized in that said encryption key is created in a random manner during the installation of said DMN agent in the first storage device (20).

4. Process according to claim 1, characterized in that the installation of the first storage device comprises the following steps:
password checking (510) of the practitioner;
random generation (520) of an encryption key stored in said storage device (20);
input/importation (540) of a nominative list of patients;
transmission (550) of a request to said first server (DMA, 300) in order to obtain a list of IDA anonymous identifiers corresponding to the locally stored nominative list,
reception (560) of said first server (DMA, 300) of the list of anonymous identifiers (IDA);
creation (570) of the first table of links (PLT, 21) integrating the nominative information as well as the anonymous identifiers known to the DMA server;
encryption (580) of said table of links (PLT, 21) by means of the key generated in the step 520.

5. Process according to claim 4 characterized in that it comprises, subsequently to the random generation of the key, the creation of a attestation/certificate allowing to confirm the creation of the encryption key.

6. Process according to claim 4 characterized in that it comprises a procedure of duplication/qualification of a storage device source (20) for the creation/qualification of a second storage device (20-n) allowing the generation of the customized medical file and the access to the nominative data (DMN), said DMN agent of the primary storage device performing the following steps:
password verification (610) of the holder of the first storage device (20) being used as source for the duplication;
verification (620) of the presence of the encrypted table (PLT) and of the encryption file (22);
verification (640, 650) of the password of the holder of the secondary storage device;
creation (660) on said secondary storage device, of the files comprising the executable file of the DMN agent, the encrypted table of links (PLT, 21), and of the file comprising the encryption key used by the first storage device (20).

7. Process according to claim 6 characterized in that the creation/qualification of said secondary device comprises the edition of an attestation and/or certificate.

8. Process according to claim 6 characterized in that it comprises the following steps intended for the update of the nominative information held in the tables of links of the various storage devices (20) belonging to the same group and using the same encryption key:
input and encryption (720) of nominative data modified or relative to a new patient;
transmission (730) of a request to the second server (TSB, 400) for its provisional storage, in an encrypted form by means of the encryption key contained in said storage device (20), of nominative information other than the anonymous identifier (IDA);
update of the local table (PLT) integrating the new modified information;
encryption of the local table (PLT) by means of the encryption key.

9. Process according to claim 8 characterized in that the agent of any storage device (20) belonging to a same group or organism performs the following steps for verifying the opportunity of an update of a local table of links (PLT, 21):
password verification (810) of the holder of the considered storage device (20);
verification (820) of the presence of the file comprising the encryption key and of the table of links (PLT, 21);
generation of a request (830) transmitted to the first DMA server (300) for obtaining the list of the anonymous identifiers stored in that serer;
identification (840) of the list of the anonymous identifiers (IDA) downloaded from said first DMA server (300);
decryption (850) of the local table of links (PLT, 21);
comparison (860) of the list of anonymous identifiers downloaded with that stored in the table (PLT, 21) and, in the case of an incompatibility (870);
generation of a request (880) with destination to said second server (TSB, 400) for downloading the nominative information which is temporarily stored therein;
update (890) of the local table of links (PLT, 21) by means of information downloaded from said second server (TSB, 400);
verification (890) of the update of all the storage devices of the same group and purge, if necessary, the data stored on said second server (TSB, 400).

10. Process according to claim 9 characterized in that it further comprises the implementation of an administrator server (200) allowing the management of the licenses and the purges of said second server (TSB, 400) when all the update of all the storage devices (20) belonging to the same group are obtained.
